(19) United States
(12) Patent Application Publication
(10) Pub. No.: US 2006/0110025 A1
(43) Pub. Date: May 25, 2006

(54) Method for inspecting mask defects

(76) Inventors: Ming Feng Ho, Hsinchu City (TW); I Wen Chang, Kaohsiung City (TW)

Correspondence Address: SMITH, GAMBRELL & RUSSELL, LLP, 1850 M STREET, N.W., SUITE 800, WASHINGTON, DC, 20036, US

(21) Appl. No.: 10/992,468

(22) Filed: Nov. 19, 2004

(51) Int. Cl. G06K 9/00

(52) U.S. Cl. 382/144

(57) ABSTRACT

A method for inspecting mask defects comprises a step of providing an image including a simulated mask pattern, at least one simulated defect and a simulated die array (or a simulated cell array), which are superimposed together, and a step of inspecting the location of the simulate defect on the simulated die array (or on the simulated cell array) and on the simulated mask pattern such that an inspector can identify the exact location of a physical defect on a physical die array of a wafer (or on a cell array or a photoelectronic substrate) and further on a physical mask pattern transferred on the die array (or on the cell array).

### BACKGROUND OF THE INVENTION

1. Field of the Invention

This invention generally relates to a method for inspecting defect on a mask, and more particularly to a method for inspecting defect on a mask, which provides a manner for an inspector to identify the exact location of a physical defect on a physical die array of a wafer (or on a cell array of a photoelectronic substrate) and further on a physical mask pattern transferred on the die array (or on the cell array).

2. Description of the Related Art

Conventionally, mask designers manufacture masks according to integrated circuit (IC) designs in semiconductor industries or thin film transistor (TFT) designs for liquid crystal display (LCD) and color filter (CF) designs in photoelectronic industries or printed circuit board (PCB) designs obtained from IC/TFT/LCD/CF/PCB designers/clients. After finishing the masks, the mask designers will provide the IC/TFT/LCD/CF/PCB designers/clients with defect maps for showing the locations of mask defects on a corresponding wafer or a photoelectronic substrate (e.g. glass substrate) onto which mask patterns of the masks will be transferred.

A mask defect on a mask is anything that is different from a desired mask pattern and that occurs during the mask manufacturing process. FIGS. 1a-1f illustrate a mask 10 representing a simple integrated circuit or photoelectronic or PCB design which contains some of the common mask defects that occur during the mask manufacturing process. The mask 10 comprises an opaque area 12, typically made of chrome, and clear areas 14 and 16 which represent the geometry patterns to be transferred onto a wafer or a photoelectronic substrate. FIG. 1a illustrates an isolated pinhole defect 18 in the opaque area 12 of the mask 10. FIG. 1b illustrates an isolated opaque spot defect 20 in the clear area 14 of the mask 10. FIG. 1c illustrates edge intrusion defects 22 in the clear areas 14 and 16 of the mask 10. FIG. 1d illustrates edge protrusion defects 24 in the opaque area 12 of the mask 10. FIG. 1e illustrates a geometry break defect 26 in the clear area 16 of the mask 10. Finally, FIG. 1f illustrates a geometry bridge defect 28 in the opaque area 12 of the mask 10.

Typically, the above defects on the mask can be inspected, for instance, by scanning the surface of the finished mask with a high resolution microscope or an inspection machine and capturing images of the mask. These mask images may then be observed by inspection engineers or mask fabrication workers to identify defects on the physical mask into different types of mask defects illustrated by FIGS. 1a-1f. The next step is determining whether or not the inspected mask is good enough for use in the lithography process. This step can be performed by a skilled-inspection engineer, or by fabrication workers possibly with the aid of inspection software. If there are no defects, or defects are discovered but determined to be within tolerances set by the manufacturer or end-user, then the mask is passed and used to expose a wafer or photoelectronic substrate. If defects are discovered and fall outside tolerances, then the mask fails the inspection, and a decision must be made as to whether the mask may be cleaned and/or repaired to correct the defects, or whether the defects are so severe that a new mask must be manufactured. Conventionally, after defects are discovered on the mask, the inspection engineers or mask fabrication workers will make a defect map for IC/TFT/LCD/CF/PCB designer/client's inspection or record regardless of whether the defects are cleaned and/or repaired or not.

FIG. 2 shows a conventional defect map 100, which is typically provided by the mask designers to the IC/TFT/LCD/CF/PCB designers/clients. The defect map 100 can provide the IC/TFT/LCD/CF/PCB designers/clients with the information for their tracing or searching the IC/TFT/LCD/CF/PCB yield issues which might be caused by the mask defects on the masks. The defect map 100 includes a die array (or a cell array) 102, consisting of a plurality of dies (or cells) 102a, on a wafer (or on a photoelectronic substrate) 104 and a plurality of mask defects 106a, 106b, 106c positioned on the dies 102a. The mask defects 106a, 106b and 106c can be any defect as shown in FIGS. 1a-f and in any die 102a. In FIG. 2, the defect 106a is an isolated pinhole defect and located on the die 102a numbered (2, 3) in the die array 102; the defect 106b and 106c are two isolated opaque spot defects and located on the die 102a numbered (2, 1) in the die array 102.

However, the defect map 100 can only provide the IC/TFT/LCD/CF/PCB designers/clients with the rough locations of the defects 106a, 106b, 106c on the dies (or the cells) 102a but cannot provide them with the exact locations of the defects 106a, 106b on the detailed circuit (i.e. the mask pattern), which will be transferred onto the dies 102a. Therefore, as the integrated circuit designs become more complicated and denser, it becomes increasingly difficult to trace or search out the circuit defects, such as short circuits or broken circuits, which might be caused by the mask defects on the masks.

In addition, the mask designers need to process with a mask data jobview, that is, to present the designed mask patterns or the defect map to the IC/TFT/LCD/CF/PCB designers/clients for inspection after finishing the masks. In order to do this, the mask designers may inform the IC/TFT/LCD/CF/PCB designers/clients and make an appointment with them in a certain place at a certain time. Such a mask data jobview may cause the IC/TFT/LCD/CF/PCB designers/clients much inconvenience and consume a lot of time and energy.

Therefore, the mask designers have developed a computer network system by which the IC/TFT/LCD/CF/PCB designers/clients can use their personal computers to connect to a computer server, provided by the mask designers, through a network thereby reviewing the designed mask patterns which have been saved on the computer server in advance. Such a computer network system brings the IC/TFT/LCD/CF/PCB designers much convenience and save a lot of time and energy. The computer network system is disclosed in Taiwan Patent No. 154779.

However, the computer network system only provides the designed mask patterns for IC/TFT/LCD/CF/PCB designer/client's review but does not provide any information for their quickly tracing or searching the IC/TFT/LCD/CF/PCB yield issues which might be caused by the mask defects on the masks.

Accordingly, the present invention provides a method for inspecting mask defects, which provides a manner for an inspector to identify the exact location of a mask defect on a die array of a wafer (or on a cell array of a photoelectronic substrate) and further on a mask pattern transferred on the die array (or the cell array). In addition, the method according to the present invention can be implemented on a computer system such that the inspector can further identify the shape and size of the mask defect on the die array (or on the cell array) and on the mask pattern by zooming in the mask defect through the computer system.

### SUMMARY OF THE INVENTION

It is an object of the present invention to provide a method for inspecting mask defects, wherein the method provides a manner for an inspector to identify the exact location of a mask defect on a die array (or on a cell array) and further on a mask pattern transferred on the die array (or on the cell array). According to this manner, the inspector can quickly trace or search the IC/TFT/LCD/CF/PCB yield issues which might be caused by the mask defect on the mask.

In order to achieve the above object, the method for inspecting mask defects comprises a step of providing an image including a simulated mask pattern, at least one simulated defect and a simulated block array, which are superimposed together, and a step of inspecting the location of the simulated defect on the simulated block array and the simulated mask pattern such that an inspector can identify the exact location of a physical defect on a physical block array and further on a physical mask pattern transferred on the block array. According to the method of the present invention, the block array can be a die array on a wafer or a cell array on a photoelectronic substrate.

The method according to the invention can be implemented on a computer system such that the inspector can further identify the shape and size of the mask defect by zooming in the mask defect through the computer system.

### BRIEF DESCRIPTION OF THE DRAWINGS

Other objects, advantages, and novel features of the present invention will become more apparent from the following detailed description when taken in conjunction with the accompanying drawings.

FIGS. 1a-1f illustrate a mask containing some of the common mask defects.

FIG. 2 is a schematic view of a conventional defect map.

FIG. 3 is a flow chart for illustrating the method for inspecting mask defects according to one embodiment of the present invention.

FIGS. 4a-4d illustrate a method for inspecting mask defects according to one embodiment of the present invention.

FIG. 5a is a superimposed image of the mask pattern image and the defect image.

FIG. 5b is a superimposed image of the mask pattern image and the block array image.

FIG. 5c is a superimposed image of the defect image and the block array image.

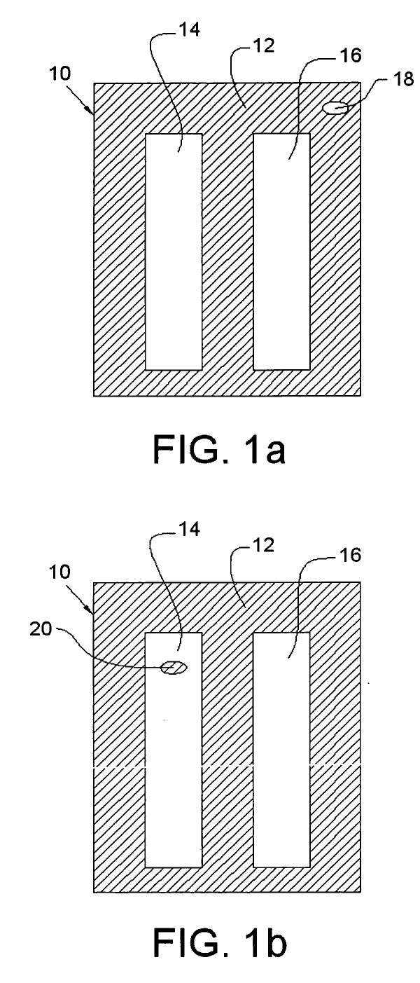

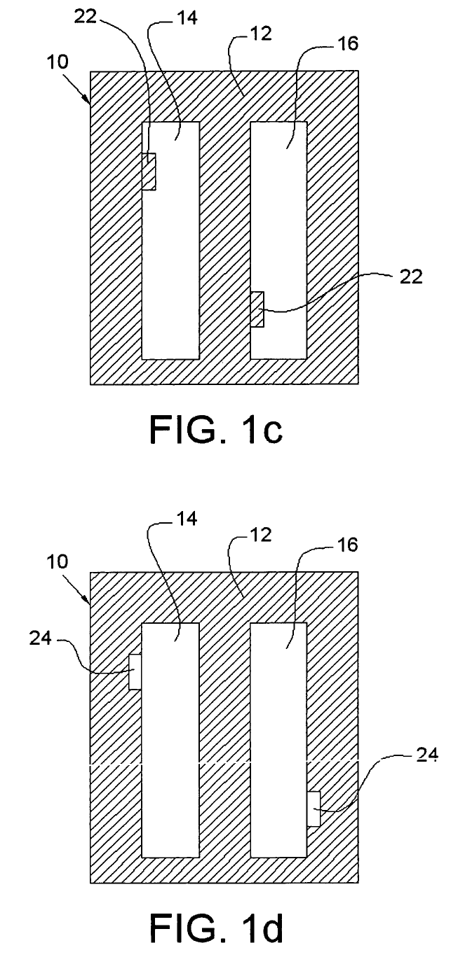

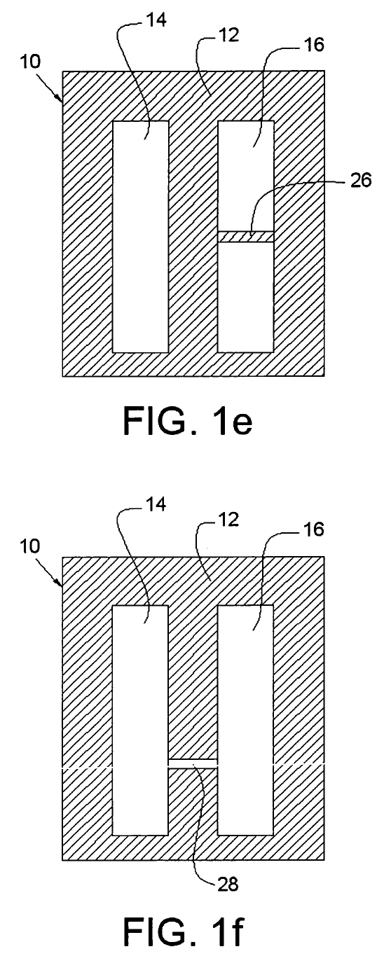

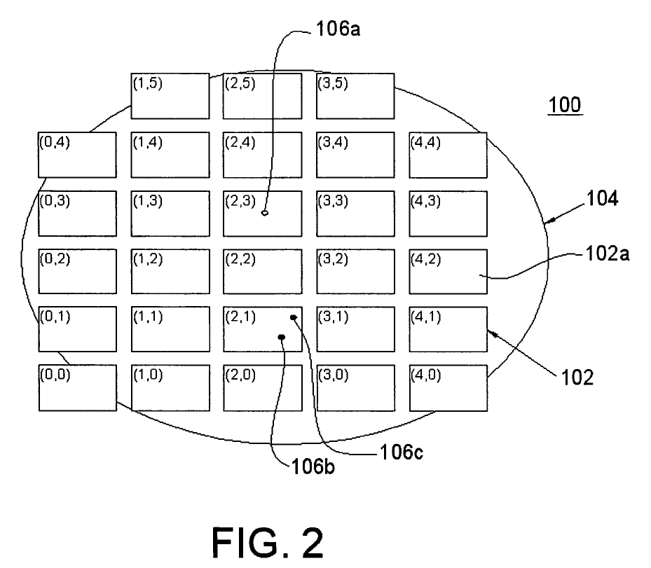

### DETAILED DESCRIPTION OF THE PREFERRED EMBODIMENT

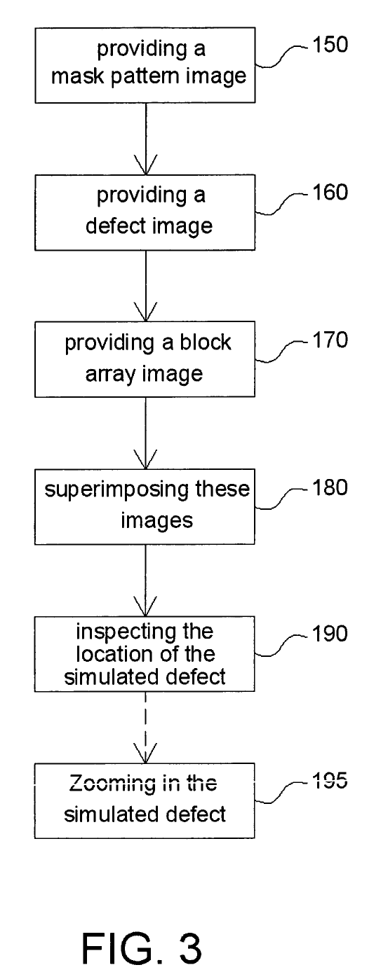

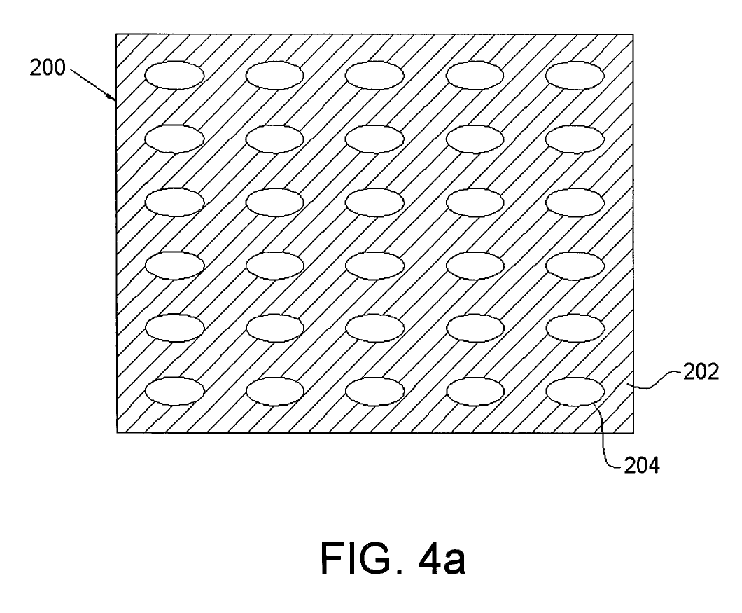

FIG. 3 is a flow chart for illustrating the method for inspecting mask defects according to one embodiment of the present invention. The present method is applied for inspecting mask defects formed on a mask, which has a physical mask pattern and three physical defects formed on the physical mask pattern. In this embodiment, it is assumed that the physical mask pattern consists of a physical opaque area and a plurality of physical clear circle areas and that there are five physical mask defects formed on the physical mask pattern. The method comprises steps 150, 160, 170, 180 and 190 as shown in FIG. 3.

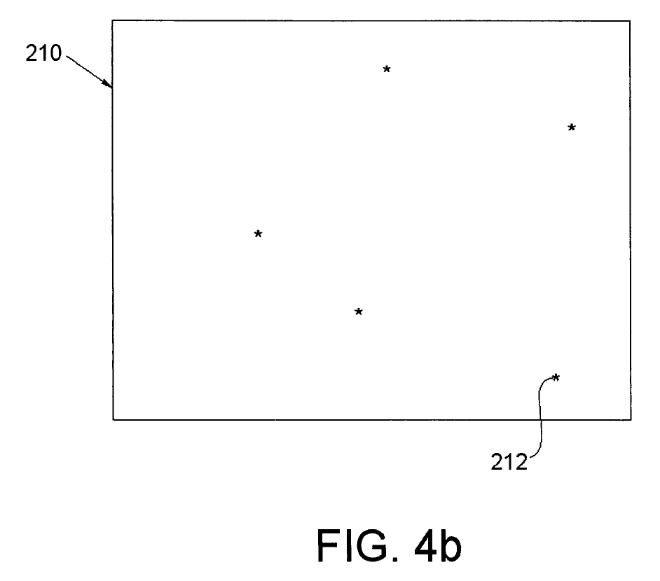

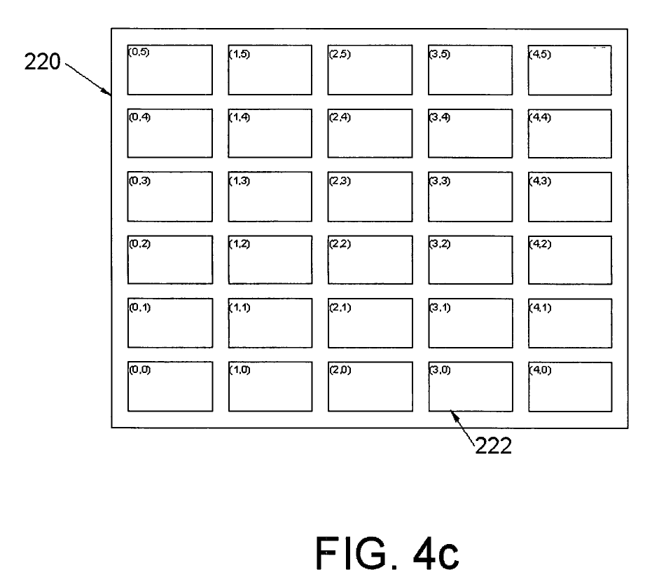

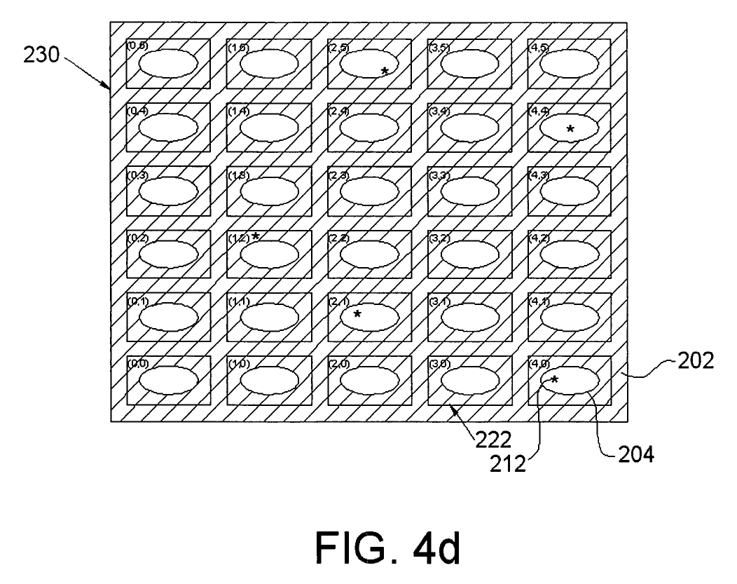

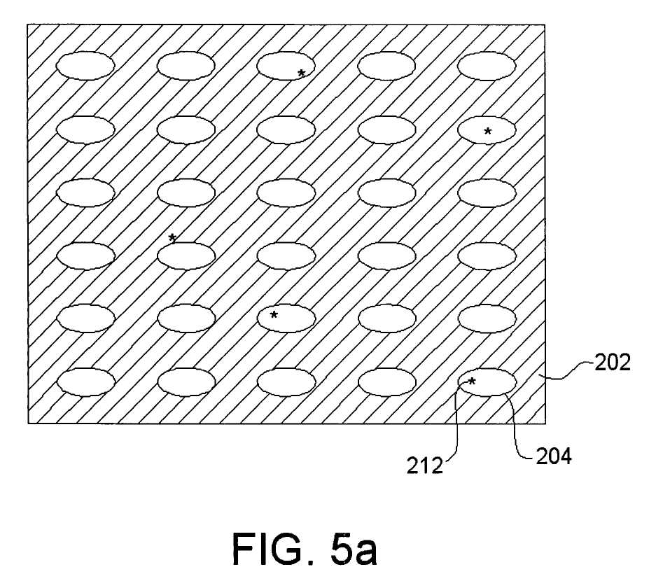

In step 150, a mask pattern image 200 is provided as shown in FIG. 4a. The mask pattern image 200 shows a simulated mask pattern for representing the physical mask pattern, wherein the mask pattern image 200 consists of a simulated opaque area 202 for representing the physical opaque area and a plurality of simulated clear circle areas 204 for representing the physical clear circle areas. It should be noted that the simulated mask pattern of the mask pattern image 200 is shown only for illustration and can be in any shape according to real circuit designs.

In step 160, a defect image 210 is provided as shown in FIG. 4b. The defect image 210 shows five simulated defects 212 for representing the five physical mask defects, wherein the five simulated defects 212 are presented by five marks, e.g. star signs and distributed on the defect image 210 according to the distributions of the physical mask defects formed on the physical mask pattern.

In step 170, a block array image 220 is provided as shown in FIG. 4c. The block array image 220 shows a simulated block array 222 for representing a physical die array (or a physical cell array) on a wafer (or on a photoelectronic substrate), to which the physical mask pattern is transferred. In this embodiment, the plurality of physical clear circle areas are respectively corresponding to and will be respectively transferred to the dies (or the cells) of the physical die array (or the physical cell array).

In step 180, the mask pattern image 200, the defect image 210 and the block array image 220 are superimposed so as to obtain a superimposed image 230 as shown in FIG. 4d. In the superimposed image 230, each simulated clear circle areas 204 are positioned on each die of the die array for showing the feature of the physical clear circle areas transferred onto the physical die array; further, the five simulated defects 212 are positioned on the simulated mask pattern for showing the positions of the five physical mask defects formed on the physical mask pattern.

In step 190, the locations of the simulated defects 212 on the simulated mask pattern and the simulated block array 222 are inspected by an inspector (IC/TFT/LCD/CF/PCB designer/client). In this step, the inspector (IC/TFT/LCD/CF/PCB designer/client) can identify and obtain the exact locations of the physical defects on the physical mask pattern (i.e. designed circuit) and on the physical die array (or the physical cell array). For example, the inspector can identify that the physical defects are located on the physical dies (or on the physical cells) numbered (1,2), (2,1), (2,5), (4,0), (4,4) and further on the physical mask pattern (i.e. designed circuit) transferred onto these physical dies (or onto these physical cells). In such a manner, the inspector can quickly trace or search the IC/TFT/LCD/CF/PCB yield issues which might be caused by the mask defects on the mask.

According to the method of the present invention, the defect image 210 can be obtained by following steps: scanning the surface of the physical mask with a high resolution microscope or an inspection machine and capturing image of the physical mask; observing the physical mask image and recording the physical defects formed on the physical mask; and drawing the defect image, e.g. by a computer drawing software, according to the distribution of the physical defects on the physical mask image. In addition, the mask pattern image 200 and the block array image 220 can be obtained from the original designed mask pattern and die array (or cell array).

Preferably, the method of the present invention can be implemented on a computer system. For example, the mask pattern image 200, the defect image 210 and the block array image 220 can be in advance saved on a storing device, e.g. hard disk, of the computer system. Then, an inspector can view these image 200, 210 and 220 through a viewing program installed on the computer system and superimpose them through this viewing program. Especially, the method of the present invention can be implemented on a computer network system by which the inspector can use their personal computers to connect to a computer server having the viewing program, which is provided by the mask designers, for viewing these images.

The method of the present invention can further comprise a step 195. In step 195, the simulated defect 212 is zoomed in such that the inspector can further identify the shape and size of each physical mask defect. The step 195 can be performed through the above-mentioned viewing program. In another embodiment of the present invention, the step 195 is selecting the simulated defects 212 and showing the physical defect images of the selected simulated defects 212 such that the inspector can further identify the real shape and size of each physical mask defect on the physical mask pattern. The step 195 can be performed through the above-mentioned viewing program. For example, each of the simulated defects 212 shown by the viewing program can be linked to its real physical defect image, e.g. captured by a high resolution microscope or an inspection machine; then the physical defect image can show up while the inspector select/click the simulated defect 212. The term “click” herein means an action in which the inspector uses an input device (e.g. a mouse) of the computer system to select the simulated defect 212 displayed on a monitor of the same.

It should be noted that the sequence of the steps 150, 160 and 170 are not limited in this embodiment; any of their sequence can still achieve the same object of the same invention.

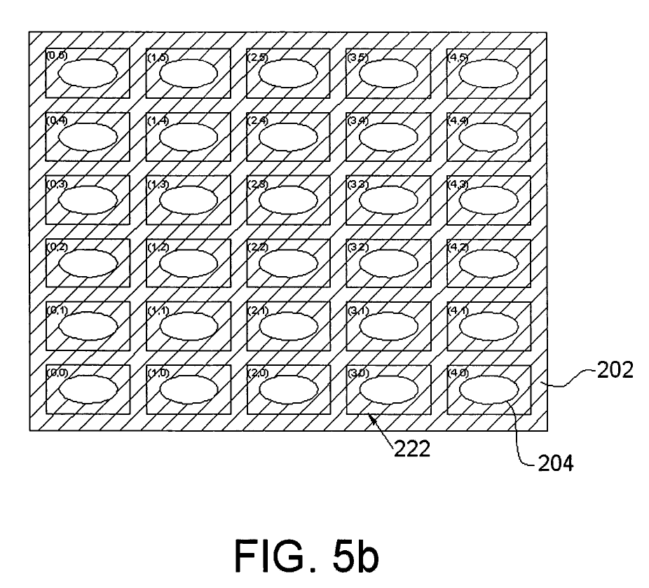

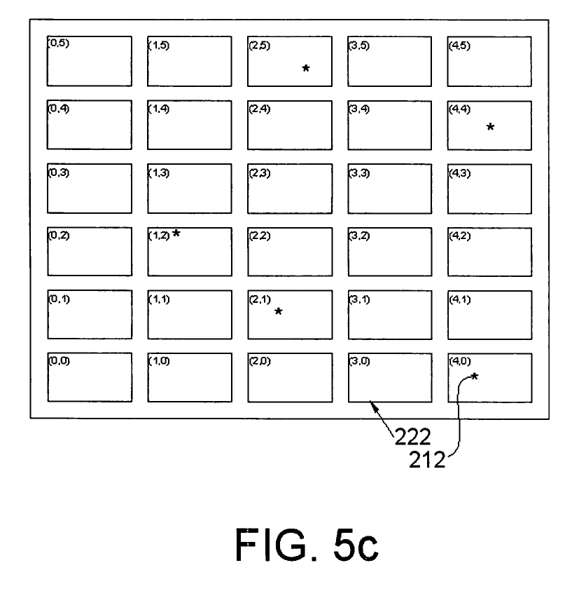

In another embodiment of the present invention, the method further comprises a step of optionally removing at least one of the mask pattern image 200, the defect image 210 and the block array image 220 from the superimposed image 230. This step can also be performed through the above-mentioned viewing program. In this step, the inspector can optionally view only one of the mask pattern image 200, the defect image 210 and the block array image 220 or view an image superimposed by any two of these image 200, 210 and 220 as shown in FIG. 5a-5c. FIG. 5a is a superimposed image of the mask pattern image 200 and the defect image 210. FIG. 5b is a superimposed image of the mask pattern image 200 and the block array image 220. FIG. 5c is a superimposed image of the defect image 210 and the block array image 220.

In one alternative embodiment of the present invention, the method comprises the following steps: providing an image as shown in FIG. 4d, which includes a simulated mask pattern, at least one simulated defect and a simulated die array (or a simulated cell array) superimposed together; and inspecting the location of the simulated defect on the simulated mask pattern or on the simulated die array (or on the simulated cell array), thereby identifying the exact location of the physical defect on the physical mask pattern or on the physical die array (or on the physical cell array). In this embodiment, the method further comprises a step of zooming in the simulated defects such that the inspector can further identify the shape and size of each physical mask defect. Alternatively, the method further comprises a step of selecting the simulated defect and showing the physical defect image of the selected simulated defect. These steps are similar to those of the above-mentioned embodiment and can be implemented or performed in the same manner.

It should be noted that the method according to the present invention can be applied to inspect defects on a mask, which is used for forming patterns on a wafer (or a photoelectronic substrate, e.g. glass substrate of LCD), such that a inspector (TFT/LCD/CF/PCB designer/client) can identify and obtain the exact locations of the physical defects on the physical mask pattern (i.e. designed circuit) and on a die array of the wafer (or on a cell array of the photoelectronic substrate).

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A method for inspecting mask defects, applied to a mask having a physical mask pattern and at least one physical defect formed on the physical mask pattern, the method comprising following steps:
providing a mask pattern image showing a simulated mask pattern for representing the physical mask pattern;
providing a defect image showing at least one simulated defect for representing the physical defect; and
superimposing the mask pattern image and the defect image; and
inspecting the location of the simulated defect on the simulated mask pattern thereby identifying the exact location of the physical defect on the physical mask pattern.

2. The method as claimed in claim 1, wherein all of the steps are implemented on a computer system.

3. The method as claimed in claim 2, wherein all of the steps are performed through a viewing program installed on the computer system.

4. The method as claimed in claim 3, wherein all of the steps are implemented on a computer network system by which an inspector can use a personal computer to connect to a computer server having the viewing program for viewing the images.

5. The method as claimed in claim 3, further comprising a step of zooming in the simulated defect on the simulated mask pattern thereby identifying the physical shape and size of the physical defect on the physical mask pattern.

6. The method as claimed in claim 3, further comprising a step of selecting the simulated defect and showing the image of the physical defect thereby identifying the physical shape and size of the physical defect on the physical mask pattern.

7. A method for inspecting mask defects, applied to a mask having a physical mask pattern and at least one physical defect formed on the physical mask pattern, the method comprising following steps:
providing a mask pattern image showing a simulated mask pattern for representing the physical mask pattern;
providing a defect image showing at least one simulated defect for representing the physical defect;
providing a block array image showing a simulated block array for representing a physical block array on a substrate to which the physical mask pattern is transferred; and
superimposing the defect image and at least one of the mask pattern image and the block array image thereby obtaining a superimposed image; and
inspecting the location of the simulated defect on at least one of the simulated mask pattern and the simulated block array thereby identifying the exact location of the physical defect on at least one of the physical mask pattern and the physical block array.

8. The method as claimed in claim 7, wherein the substrate is one of a wafer and a photoelectronic substrate, and the physical block array is one of a physical die array on the wafer and a physical cell array on the photoelectronic substrate.

9. The method as claimed in claim 7, wherein all of the steps are implemented on a computer system.

10. The method as claimed in claim 9, wherein all of the steps are performed through a viewing program installed on the computer system.

11. The method as claimed in claim 10, wherein all of the steps are implemented on a computer network system by which an inspector can use a personal computer to connect to a computer server having the viewing program for viewing the images.

12. The method as claimed in claim 10, further comprising a step of zooming in the simulated defect on at least one of the simulated mask pattern and the simulated block array thereby identifying the physical shape and size of the physical defect on at least one of the physical mask pattern and the physical block array.

13. The method as claimed in claim 10, further comprising a step of selecting the simulated defect and showing the image of the physical defect thereby identifying the physical shape and size of the physical defect on the physical mask pattern.

14. The method as claimed in claim 10, further comprising a step of optionally removing at least one of the mask pattern image, the defect image and the block array image from the superimposed image.

15. A method for inspecting mask defects, applied to a mask having a physical mask pattern and at least one physical defect formed on the physical mask pattern, the method comprising following steps:
providing an image which includes a simulated mask pattern for representing the physical mask pattern and at least one simulated defect positioned on the simulated mask pattern for representing the physical defect; and
inspecting the location of the simulated defect on the simulated mask pattern thereby identifying the exact location of the physical defect on the physical mask pattern.

16. The method as claimed in claim 15, wherein all of the steps are implemented on a computer system.

17. The method as claimed in claim 16, wherein all of the steps are performed through a viewing program installed on the computer system.

18. The method as claimed in claim 17, wherein all of the steps are implemented on a computer network system by which an inspector can use a personal computer to connect to a computer server having the viewing program for viewing the images.

19. The method as claimed in claim 17, further comprising a step of zooming in the simulated defect on the simulated mask pattern thereby identifying the physical shape and size of the physical defect on the physical mask pattern.

20. The method as claimed in claim 15, wherein the image further includes a simulated block array for representing a physical block array on a substrate to which the physical mask pattern is transferred.

21. The method as claimed in claim 20, wherein the substrate is one of a wafer and a photoelectronic substrate, and the physical block array is one of a physical die array on the wafer and a physical cell array on the photoelectronic substrate.

22. The method as claimed in claim 20, further comprising a step of inspecting the location of the simulated defect on the simulated block array thereby identifying the exact location of the physical defect on the physical block array.
